(19) United States
(12) Patent Application Publication
(10) Pub. No.: US 2024/0045242 A1
(43) Pub. Date: Feb. 8, 2024

(54) DISPLAY DEVICE AND DISPLAY TERMINAL

(71) Applicant: WUHAN CHINA STAR OPTOELECTRONICS TECHNOLOGY CO., LTD., Wuhan, Hubei (CN)

(72) Inventors: Qian Deng, Wuhan, Hubei (CN); Wei Cheng, Wuhan, Hubei (CN); Rui He, Wuhan, Hubei (CN); Wenlong Ye, Wuhan, Hubei (CN)

(73) Assignee: WUHAN CHINA STAR OPTOELECTRONICS TECHNOLOGY CO., LTD., Wuhan, Hubei (CN)

(21) Appl. No.: 17/622,991

(22) PCT Filed: Dec. 20, 2021
(86) PCT No.: PCT/CN2021/139784

§ 371 Date: Dec. 27, 2021

(30) Foreign Application Priority Data
Dec. 14, 2021 (CN) 202111532123.6

(51) Int. Cl. G02F 1/13; G02F 1/1334; G02F 1/1335; G02F 1/1347

(52) U.S. Cl. CPC G02F 1/1323; G02F 1/13345; G02F 1/133531; G02F 1/1347; G02F 2202/04

(57) ABSTRACT

An embodiment of the present application discloses a display device and display terminal. The display device includes a first display panel configured to display images and a second display panel configured for an anti-peep effect. The second display panel includes a liquid crystal mixture, the liquid crystal mixture includes liquid crystals and dyes. molecules of liquid crystals and molecules of dyes are aligned consistently. The display device has excellent anti-peep effect, high brightness, thin thickness and can simultaneously achieve the anti-peep function in three positions.

### FIELD OF INVENTION

The present application relates to a field of displays, especially to a display device and display terminal.

### BACKGROUND OF INVENTION

With the advancement of technology and the iteration of consumer electronics products, users also pay increasing attention to the issue of privacy protection. In some occasions, people do not want others to watch the display screen images on the display device, and thus the display device is required to have an anti-peep function to prevent others from viewing the contents of the screen images in a range of a viewing angle of liquid crystals display device. An anti-peep display device provides target users with protected content readability within a viewing angle, and reduces the visibility of content at off-axis locations for anti-peep.

However, a general anti-peep display device disposed a layer of an anti-peep film cover a display screen, but such anti-peep film is bidirectional anti-peep. To achieve a full viewing angle anti-peep, attachment of two layers of orthogonal anti-peep films is required, which drastically lowers a display brightness and increases a total thickness.

### SUMMARY OF INVENTION

### Technical Issue

The embodiment of the present application provides a display device and display terminal that can solve an issue of poor anti-peep effect, low brightness, large thickness existing in a conventional anti-peep display device.

### Technical Solution

The embodiment of the present application provides a display device comprising:
a first display panel, configured to display images; and
a second display panel disposed on a display side of the first display panel, wherein the second display panel comprises a first substrate, a second substrate, a first polarizer, a second polarizer, and a liquid crystal mixture, the first polarizer is disposed on a side of the first substrate away from the second substrate, the second polarizer is disposed on a side of the second substrate away from the first substrate, and the liquid crystal mixture is sandwiched between the first substrate and the second substrate;
wherein the liquid crystal mixture comprises liquid crystals and dyes, an alignment of molecules of the liquid crystals is consistent with an alignment of molecules of the dyes, the molecules of the liquid crystals and the molecules of the dyes are tilted relative to a surface of the first substrate.

Optionally, in some embodiments of the present application, the second display panel further comprises a polymer network located between the first substrate and the second substrate, the polymer network is tilted relative to the surface of the first substrate, a tilt direction of the polymer network relative to the surface of the first substrate is consistent with a tilt direction of the molecules of the liquid crystals relative to the surface of the first substrate.

Optionally, in some embodiments of the present application, a transmission axis of the first polarizer is parallel to a transmission axis of the second polarizer, the transmission axes of the first polarizer and the second polarizer are parallel to a projection of long axes of the molecules of the liquid crystals on the first substrate surface.

Optionally, in some embodiments of the present application, an included angle between the long axes of the molecules of the liquid crystals and the surface of the first substrate and an included angle between long axes of the molecules of the dyes and the surface of the first substrate are 45 to 90 degrees.

Optionally, in some embodiments of the present application, a mass ratio of the dyes in the liquid crystal mixture is 1% to 5%.

Optionally, in some embodiments of the present application, the first display panel further comprises a third substrate and a third polarizer, a display unit is disposed on the third substrate, the third polarizer is disposed between the third substrate and the first substrate, and a light transmission axis of the third polarizer is parallel to the transmission axis of the first polarizer.

Optionally, in some embodiments of the present application, the third polarizer and the first polarizer are the same polarizer.

Optionally, in some embodiments of the present application, the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

Optionally, in some embodiments of the present application, the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

Optionally, in some embodiments of the present application, the dyes comprise azo dyes or anthraquinone dyes.

Accordingly, the embodiment of the present application further provides a display terminal comprising a terminal body and a display device, wherein the terminal body and the display device are assembled integrally, and the display device comprises:
a first display panel, configured to display images; and
a second display panel disposed on a display side of the first display panel, wherein the second display panel comprises a first substrate, a second substrate, a first polarizer, a second polarizer, and a liquid crystal mixture, the first polarizer is disposed on a side of the first substrate away from the second substrate, the second polarizer is disposed on a side of the second substrate away from the first substrate, and the liquid crystal mixture is sandwiched between the first substrate and the second substrate;
wherein the liquid crystal mixture comprises liquid crystals and dyes, an alignment of molecules of the liquid crystals is consistent with an alignment of molecules of the dyes, the molecules of the liquid crystals and the molecules of the dyes are tilted relative to a surface of the first substrate.

Optionally, in some embodiments of the present application, the second display panel further comprises a polymer network located between the first substrate and the second substrate, the polymer network is tilted relative to the surface of the first substrate, a tilt direction of the polymer network relative to the surface of the first substrate is consistent with a tilt direction of the molecules of the liquid crystals relative to the surface of the first substrate.

Optionally, in some embodiments of the present application, a transmission axis of the first polarizer is parallel to a transmission axis of the second polarizer, the transmission axes of the first polarizer and the second polarizer are parallel to a projection of long axes of the molecules of the liquid crystals on the first substrate surface.

Optionally, in some embodiments of the present application, an included angle between the long axes of the molecules of the liquid crystals and the surface of the first substrate and an included angle between long axes of the molecules of the dyes and the surface of the first substrate are 45 to 90 degrees.

Optionally, in some embodiments of the present application, wherein a mass ratio of the dyes in the liquid crystal mixture is 1% to 5%.

Optionally, in some embodiments of the present application, the first display panel further comprises a third substrate and a third polarizer, a display unit is disposed on the third substrate, the third polarizer is disposed between the third substrate and the first substrate, and a light transmission axis of the third polarizer is parallel to the transmission axis of the first polarizer.

Optionally, in some embodiments of the present application, the third polarizer and the first polarizer are the same polarizer.

Optionally, in some embodiments of the present application, the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

Optionally, in some embodiments of the present application, the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

Optionally, in some embodiments of the present application, the dyes comprise azo dyes or anthraquinone dyes.

### Advantages

The embodiment of the present application provides a display device and display terminal, the display device comprises a first display panel configured to display images and a second display panel configured for an anti-peep effect. The second display panel is disposed on a display side of the first display panel, and the second display panel comprises a first polarizer, a second polarizer, and a liquid crystal mixture. The liquid crystal mixture comprises liquid crystals and dyes. An alignment of molecules of the liquid crystals is consistent with an alignment of molecules of the dyes. The molecules of the liquid crystals and the molecules of the dyes are tilted relative to a surface of the first substrate. Light of the first display panel, when passing through the first polarizer and the second polarizer, only declines once, which simultaneously achieves a large viewing angle anti-peep effect in three positions and substantially can cover a range of privacy protection required by users. The display device of the embodiment of the present application has excellent anti-peep effect, high brightness, thin thickness and can simultaneously achieve the anti-peep function in three positions.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a first schematic structural view of a display device provided by an embodiment of the present application;

FIG. 2 is a schematic view of a pre-tilt angle of molecules of liquid crystals provided by the embodiment of the present application;

FIG. 3 is a schematic view of anti-peep effects in various positions of the display device provided by the embodiment of the present application;

FIG. 4 is a first schematic view of a x direction working principle of the display device provided by the embodiment of the present application;

FIG. 5 is a second schematic view of a x direction working principle of the display device provided by the embodiment of the present application;

FIG. 6 is a first schematic view of a z direction working principle of the display device provided by the embodiment of the present application;

FIG. 7 is a second schematic view of a z direction working principle of the display device provided by the embodiment of the present application;

FIG. 8 is a third schematic view of z direction working principle of the display device provided by the embodiment of the present application;

FIG. 9 is a second schematic structural view of the display device provided by the embodiment of the present application;

FIG. 10 is a third schematic structural view of the display device provided by the embodiment of the present application;

FIG. 11 is a fourth schematic structural view of the display device provided by the embodiment of the present application;

FIG. 12 is a schematic view of a flowchart of the display device manufacturing method provided by the embodiment of the present application;

FIG. 13 is a schematic view of a liquid crystal mixture processed with an alignment process during manufacturing a second display panel provided by the embodiment of the present application; and

FIG. 14 is a schematic view of the display device terminal provided by the embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application. In addition, it should be understood that the specific embodiments described here are only used to illustrate and explain the present application, and are not used to limit the present application. In the present application, the used orientation terminologies such as “upper” and “lower”, when are not specified to the contrary explanation, usually refer to the upper and lower states of the device in actual use or working conditions, specifically according to the direction of the figures in the drawings. Furthermore, “inner” and “outer” refer to the outline of the device.

An embodiment of the present application provides a display device comprising: a first display panel, configured to display images; and a second display panel disposed on a display side of the first display panel, wherein the second display panel comprises a first substrate, a second substrate, a first polarizer, a second polarizer, and a liquid crystal mixture, the first polarizer is disposed on a side of the first substrate away from the second substrate, the second polarizer is disposed on a side of the second substrate away from the first substrate, and the liquid crystal mixture is sandwiched between the first substrate and the second substrate; wherein the liquid crystal mixture comprises liquid crystals and dyes, an alignment of molecules of the liquid crystals is consistent with an alignment of molecules of the dyes, the molecules of the liquid crystals and the molecules of the dyes are tilted relative to a surface of the first substrate.

The embodiment of the present application provides a display device and a display terminal that are described in detail respectively as follows. It should be explained that a description order of the following embodiments has no limit to a preferred order of the embodiments.

### First Embodiment

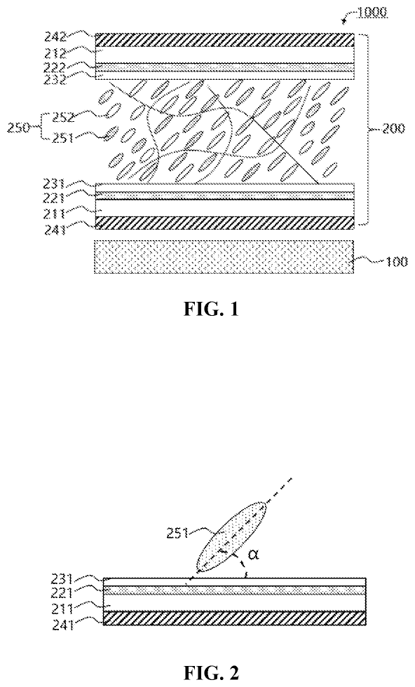

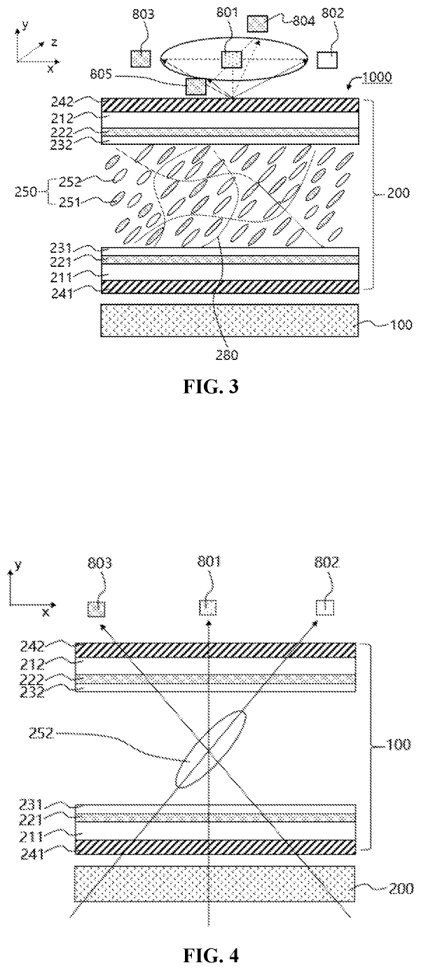

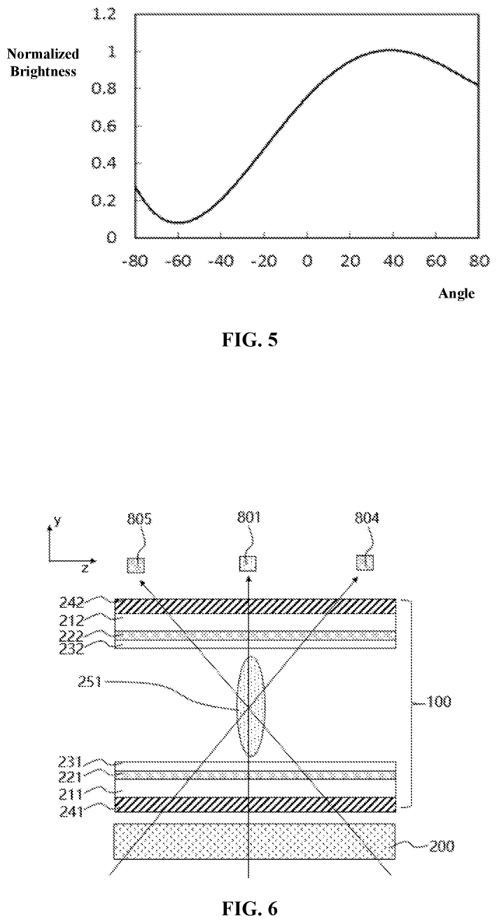

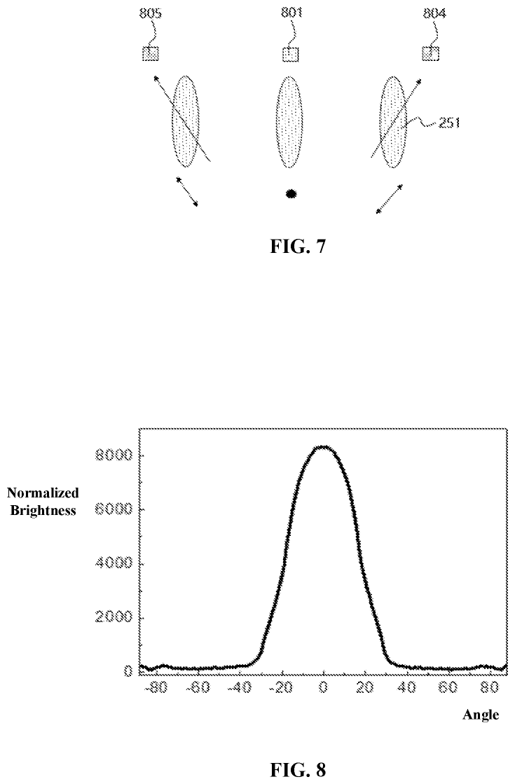

With reference to FIG. 1, FIG. 2, FIG. 3, FIG. 4, FIG. 5, FIG. 6, FIG. 1 is a first schematic structural view of a display device 1000 provided by an embodiment of the present application; FIG. 2 is a schematic view of a pre-tilt angle of molecules of liquid crystals provided by the embodiment of the present application; FIG. 3 is a schematic view of anti-peep effects in various positions of the display device 1000 provided by the embodiment of the present application; FIG. 4 is a first schematic view of a x direction working principle of the display device 1000 provided by the embodiment of the present application; FIG. 5 is a second schematic view of a x direction working principle of the display device 1000 provided by the embodiment of the present application; FIG. 6 is a first schematic view of a z direction working principle of the display device 1000 provided by the embodiment of the present application; FIG. 7 is a second schematic view of a z direction working principle of the display device 1000 provided by the embodiment of the present application; FIG. 8 is a third schematic view of z direction working principle of the display device 1000 provided by the embodiment of the present application.

The embodiment of the present application provides a display device 1000. The display device 1000 comprises a first display panel 100, a second display panel 200, The first display panel 100 is configured to display images. The second display panel 200 is disposed on a display side of the first display panel 100, and the second display panel 200 comprises a first substrate 211, a second substrate 212, a first polarizer 241, a second polarizer 242, and a liquid crystal mixture 250. The first polarizer 241 is disposed on a side of the first substrate 211 away from the second substrate 212. The second polarizer 242 is disposed on a side of the second substrate 212 away from the first substrate 211. The liquid crystal mixture 250 is sandwiched between the first substrate 211 and the second substrate 212. The liquid crystal mixture 250 comprises liquid crystals 251 and dyes 252. An alignment of molecules of the liquid crystals 251 is consistent with an alignment of molecules of the dyes 252. The molecules of the liquid crystals 251 and the molecules of the dyes 252 are tilted relative to a surface of the first substrate 211.

In some embodiments, the second display panel 200 further comprises a polymer network 280 located between the first substrate 211 and the second substrate 212. The polymer network 280 is tilted relative to the surface of the first substrate 211. A tilt direction of the polymer network 280 relative to the surface of the first substrate 211 is consistent with a tilt direction of the molecules of the liquid crystals 251 relative to the surface of the first substrate 211.

In particular, the polymer network 280 performs a function of fixing an alignment angle of the molecules of the liquid crystals 251 such that the molecules of the liquid crystals 251 keeps a constant alignment angle on the first substrate 211.

In some embodiments, a transmission axis of the first polarizer 241 is parallel to a transmission axis of the second polarizer 242. The transmission axes of the first polarizer 241 and the second polarizer 242 are parallel to a projection of the long axes of the molecules of the liquid crystals 251 on the surface of the first substrate 211.

In some embodiments, both an included angle of long axes of the molecules of the liquid crystals 251 and the surface of the first substrate 211 and an included angle between long axes of the molecules of the dyes 252 and the surface of the first substrate 211 are 45 to 90 degrees.

In particular, as shown in FIG. 1, the molecules of the liquid crystals 251 and the molecules of the dyes 252 are aligned consistently, which means that the molecules of the liquid crystals 251 and the molecules of the dyes 252 have the same alignment direction. The molecule of the liquid crystals of the liquid crystals 251 comprises a long axis and a short axis. The molecule of the dyes 252 comprises a long axis and a short axis. After an alignment of the liquid crystal molecules of the liquid crystals 251, a force among the molecules drives the molecules of the dyes 252 to be aligned in the same direction. A long axis direction of the molecules of the liquid crystals 251 is consistent with a long axis direction of the molecules of the dyes 252.

In particular, the included angle α between the molecules of the liquid crystals 251 and the surface of the first substrate 211 is 45 to 90 degrees (namely, the pre-tilt angle is 45 to 90 degrees) such that the second display panel 200 has a function of adjusting a viewing angle of the displayed images of the first display panel 100.

In particular, the display device 1000 further comprises a first alignment layer 231 disposed on a surface of a first electrode 221, or/and a second alignment layer 232 disposed on a surface of a second electrode 222. The first alignment layer 231 and the second alignment layer 232 are configured to align the molecules of the liquid crystals 251. An included angle between a rubbing direction (an alignment direction of rubbing alignment) of the first alignment layer 231 and the second alignment layer 232 is 0° or 180°.

In some embodiments, a mass ratio of the dyes 252 in the liquid crystal mixture 250 is 1% to 5%.

In particular, to guarantee an entire transmittance of the display device while achieving anti-peep effect in three positions, preferably, the mass ratio of the dyes 252 in the liquid crystal mixture 250 is 1% to 5%, and can guarantee a suitable transmittance of a front viewing angle and a large viewing angle anti-peep effect of the display device.

In some embodiments, the dyes 252 comprise azo dyes or anthraquinone dyes.

In particular, the dyes 252 comprise azo dyes or anthraquinone dyes, azo dyes or anthraquinone dyes and have advantages of excellent light resistance fastness, excellent chemical stability, and convenience of use. The azo dyes or anthraquinone dyes are dichroism materials.

In particular, dichroism dyes molecules has dichroism, the molecule has a light absorbing axis that can selectively absorb polarized light parallel to the light absorbing axis, and it generally can absorb red light, yellow light, blue light or all colors of visible light. In a “guest-host” system of liquid crystals and dichroism dyes, after liquid crystals of a body material are aligned, dyes molecules is commonly aligned according a “guest-host” effect. Dichroism pigment dyes has a shape of a molecule similar to ellipsoid of liquid crystals, and has a light absorbing axis with a stronger light absorbing effect and can absorb polarized light parallel to the light absorbing axis. Light perpendicular to the light absorbing axis direction would pass, and a difference between a light transmission part and a light absorbing part are only expressed by a dichroism ratio.

In particular, the first display panel 100 is configured to display images, the first display panel 100 can be a liquid crystal display panel or organic light emitting display panel, and a type of the first display panel 100 is not limited here.

In particular, the first display panel 100 displays images, or a side of the first display panel 100 for observation of human's eyes is the display side.

In particular, the second display panel 200 is display panel with an anti-peep effect, or a display panel with viewing angle adjustment.

In particular, display light of the first display panel 10, after entering the first polarizer 241, becomes a polarized light. After modulation of the molecules of the liquid crystals 251 or/and the molecules of the dyes 252 in the liquid crystal mixture 250, when observation is performed in different viewing angles, display light adjusts a brightness of a corresponding viewing angle through energies of different viewing angles and different illuminances to adjust the activation and deactivation of the anti-peep effect of the display device 1000.

In particular, as shown in FIG. 3, FIG. 3 illustrates anti-peep effects or display effects of large viewing angle (a side viewing angle or an oblique viewing angle) of various positions of the display device 1000 of the present embodiment. Here, long axes of the molecules of the liquid crystals 251 or/and the molecules of the dyes 252 parallel to x axis are taken as an example for explanation, a x axis, a y axis, and a z axis constitute a three dimensional coordinate system. The x axis and the y axis constitute or indicate a first plane, the z axis indicates a direction perpendicular to the first plane, or a x direction indicates a first direction, a y direction indicates a second direction, a z direction indicates a third direction. When viewed by human's eyes, the display device 1000 comprises a first position 801, a second position 802, a third position 803, a fourth position 804, and a fifth position 805. The first position 801 refers to a front view angle of the display device 1000. The second position 802 refers to an oblique view angle of the display device 1000. A position angle of the second position 802 is an oblique viewing angle of 0 degree, for example, a position angle is 0 degree, a polar angle is 60 degrees. The third position 803 refers to an oblique viewing angle of the display device 1000. A position angle of the third position 803 is an oblique view angle of 180 degree, for example, a position angle is 180 degree, and a polar angle is 60 degrees. The fourth position 804 refers to an oblique viewing angle of the display device 1000, a position angle of the fourth position 804 is an oblique viewing angle of 90 degrees, for example, a position angle is 90 degrees, and a polar angle is 60 degrees. The fifth position 805 refers to an oblique viewing angle of the display device 1000, a position angle of the fifth position 805 is an oblique viewing angle of 270 degree, for example, a position angle is 270 degree, and a polar angle is 60 degrees.

It should be explained that the molecules of the liquid crystals 251 form an included angle on the first substrate 211. Schematic views of the embodiment of the present application indicate that the molecules of the liquid crystals 251 are tilted on the first substrate 211 along the x direction. For example, as shown in FIG. 4, a tilt direction of long axes of the molecules of the liquid crystals 251 on the first substrate 211 is defined as a direction of position angle of 0 degree, and a reverse direction relative to the direction of position angle of 0 degree is a direction of position angle of 180 degree. A direction of position angle of 90 degrees and a direction of position angle of 270 degree are perpendicular to the direction of position angle of 0 degree.

It should be explained that the polar angle indicates a viewing angle under a position angle, namely, the polar angle indicates an included angle between human's eyes or sight and a normal of a surface of the second substrate 212 or a surface of the display device 1000. It should be explained that both side view and oblique view refers to an observation of a large viewing angle in a certain position angle.

It should be explained that in FIG. 3, a filling degree in the first position 801, the second position 802, the third position 803, the fourth position 804, and the fifth position 805 indicates a brightness, the lower the filling degree is, the greater the brightness is. The greater the filling degree is, the lower brightness is.

In particular, the brightness of the third position 803, the fourth position 804, and the fifth position 805 is very low, the brightness of the first position 801 is greater, the brightness of the second position 802 is the greatest. The brightness of display contents of the first display panel 100 view by Users or bystanders, in the third position 803, the fourth position 804, and the fifth position 805 is very low such that the images of the first display panel 100 cannot be viewed very well. Therefore, the third position 803, the fourth position 804, the fifth position 805 are anti-peep positions or anti-peep viewing angles, and the first position 801 and the second position 802 are normal viewing positions or normal viewing angles.

In particular, with reference to FIG. 4 and FIG. 5, FIG. 4 is a cross-sectional schematic structural view of the x direction of the display device 1000 in FIG. 3. FIG. 5 indicates a brightness variation curve chart of sequential variation of viewing angles of the third position 803, the first position 801, and the second position 802. An abscissa of FIG. indicates a value of a polar angle of the viewing angle. An ordinate of FIG. 5 indicates a normalized brightness. FIGS. 4 and 5 indicates anti-peep effects and principles of the second position 802 and the third position 803. The third position 803 and the second position 802 indicate a left-right viewing angle along the x direction. In the second position 802, when observing along a tilt direction of the molecules of the dyes 252, the observer or human's eyes see along a direction of the short axis of the molecules of the dyes 252, namely a light transmission direction. In the meantime, light absorbing is comparatively weak, display contents of the first display panel 100 can be viewed clearly on the second position 802 under a side viewing condition. When observing in the third position 803 along a direction perpendicular to the tilt direction of the molecules of the dyes 252, the observe or human's eyes see along a direction of the long axis of the molecules of the dyes 252, namely, the direction of the light absorbing axis of the molecules of the dyes 252. In the meantime linearly polarized light passing through the first polarizer 241 is absorbed, the brightness of display contents of the first display panel 100 in the third position 803 under a side viewing angle is lowered drastically, and image readability is drastically weakened to achieve the anti-peep effect.

In particular, with reference to FIG. 6, FIG. 7, and FIG. 8, FIG. 6 is a cross-sectional schematic structural view of the z direction of the display device 1000 in FIG. 3. FIG. 8 indicates a brightness variation curve chart of sequential variation of viewing angles the fifth position 805, the first position 801, and the fourth position 804. An abscissa of FIG. 8 indicates a value of a polar angle of the viewing angle. An ordinate of FIG. 8 indicates a normalized brightness. FIG. 7 indicates a relationship between incident light from the fifth position 805, the first position 801, the fourth position 804 into the second display panel 200 and the molecules of the liquid crystals 251. FIG. 6, FIG. 7, FIG. 8 indicates anti-peep effects and principles of the fifth position 805, the fourth position 804. FIG. 8 also explains a principle of the first position 801 that the brightness is decreased. The fifth position 805 and the fourth position 804 indicate a left-right viewing angle along the z direction. When observation is performed in the front viewing angle (the first position 801), the polarization axis of the first polarizer 241 is consistent with a direction of an orthographic projection of the long axes of the molecules of the liquid crystals 251 on the first polarizer 241, a polarization direction of the incident linearly polarized light is not modulated, and a polarization direction of exiting linearly polarized light is unchanged. When observation is performed from the fifth position 805, the fourth position 804, a certain included angle exists between the polarization axis of the first polarizer 241 and the orthographic projection of the long axes of the molecules of the liquid crystals 251 on the first polarizer 241, incident linearly polarized light, after passing through liquid crystals layer, has an anisotropic phase difference such that light in the fifth position 805 and the fourth position 804 passing through the liquid crystals 251 becomes elliptically polarized light. After light filtration of the second polarizer 242, the brightness of the screen images observed in the fifth position 805, the fourth position 804 is drastically lowered comparing to the screen images brightness of the front viewing angle (the first position 801) such that the brightness of the display contents of the first display panel 100 in the fifth position 805 and the fourth position 804 under a side viewing angle is lowered drastically, and image readability is drastically weakened to achieve the anti-peep effect.

It should be explained that the transmission axis of the polarizer is a polarization axis thereof, or the transmission axis of the polarizer is parallel to a polarization axis thereof.

In particular, the anti-peep effect of the third position 803 is according to a modulation effect of the molecules of the dyes 252, and the anti-peep effects of the fifth position 805 and the fourth position 804 are according to a modulation effect of the molecules of the liquid crystals 251.

In particular, the display device 1000 has an anti-peep function in three positions that are the third position 803, the fifth position 805, the fourth position 804.

It should be explained that in the present embodiment, the molecules of the liquid crystals 251 and the molecules of the dyes 252 in the second display panel provides a display device 1000. The display device 1000 comprises a first display panel 100 configured to display images, and a second display panel 200 configured for an anti-peep effect. The second display panel 200 is disposed on a display side of the first display panel 100. The second display panel 200 comprises the liquid crystal mixture 250 in which liquid crystals 251 and dyes 252 are mixed. The molecules of the liquid crystals 251 and the molecules of the dyes 252 are aligned consistently. The molecules of the liquid crystals 251 are obliquely aligned on a surface of the first substrate and a surface of the second substrate in the second display panel 200. The transmission axis of the first polarizer 241 and the transmission axis of the second polarizer 242 in the second display panel 200 are parallel to the projection of the long axes of the molecules of the liquid crystals 251 on the surface of the first substrate 211. The transmission axis of the first polarizer 241 is parallel to the transmission axis of the second polarizer 242, a modulation effect of the molecules of the dyes 252 makes the third position 803 have an anti-peep effect, a modulation effect of the molecules of the liquid crystals 251 makes the fifth position 805 and the fourth position 804 have an anti-peep effect. The display device 1000 of the present embodiment achieves an anti-peep function in three positions. In the meantime, the display device of the embodiment of the present application 1000 has excellent anti-peep effect, high brightness, thin thickness

### Second Embodiment

The present embodiment is the same as or similar to the embodiment, and a difference is that the structure of the display device 1000 is described.

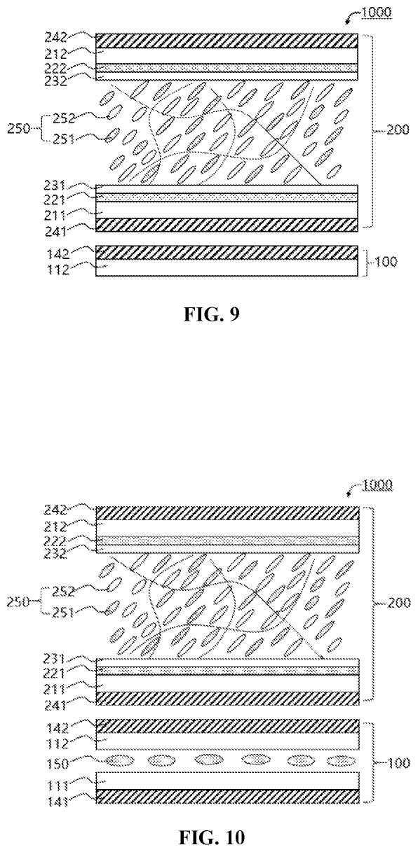

With reference to FIG. 9, FIG. 9 is a second schematic structural view of the display device 1000 provided by the embodiment of the present application.

In some embodiments, the first display panel 100 further comprises a third substrate 112 and a third polarizer 142. A display unit is disposed on the third substrate 112. The third polarizer 142 is disposed between the third substrate 112 and the first substrate 211. A transmission axis of the third polarizer 142 is parallel to the transmission axis of the first polarizer 241.

In particular, the first display panel 100 further comprises the third substrate 112, a display unit can be disposed on the third substrate 112. The first display panel 100 can be a liquid crystal display panel, an organic light emitting display panel, etc.

In particular, the first display panel 100 can be an organic light emitting display panel. A display unit is disposed on the third substrate 112, and the display unit can comprise a red light emitting device, a green light emitting device, a blue light emitting device, etc.

In particular, display light of the first display panel 100, after passing through the third polarizer 142, becomes first polarized light. Because the transmission axis of the third polarizer 142 is parallel to the transmission axis of the first polarizer 241, therefore, the first polarized light can complete pass through the first polarizer 241 such that the second display panel 200 performs the function.

In particular, the first display panel 100 can also comprise an array substrate, for example, an array film layer or/and light emitting device layer is disposed on the third substrate 112, and the array film layer can comprise each film layer of the thin film transistor.

In the present embodiment, the first polarizer 241 is parallel to the transmission axis of the second polarizer 242, and the transmission axis of the third polarizer 142 is parallel to the transmission axis of the first polarizer 241. Display light of the first display panel 100, after passing through the third polarizer 142, can completely pass through the first polarizer 241. The display device 1000 has a high brightness effect. The display device 1000 of the embodiment of the present application has excellent anti-peep effect, high brightness, thin thickness and can simultaneously achieve the anti-peep function in three positions.

### Third Embodiment

The present embodiment is the same as or similar to the above embodiment, and a difference is that the display device 1000 is further described.

With reference to FIG. 10, FIG. 10 is a third schematic structural view of the display device 1000 provided by the embodiment of the present application.

In some embodiments, the first display panel 100 is a liquid crystal display panel, the first display panel 100 further comprises a fourth substrate 111 and a fourth polarizer 141. The fourth substrate 111 is disposed on a side of the third substrate 112 away from the third polarizer 142. The fourth polarizer 141 is disposed on a side of the fourth substrate 111 away from the third substrate 112.

In particular, the first display panel 100 is a liquid crystal display panel, the first display panel 100 comprises the third substrate 112 and the fourth substrate 111. Display liquid crystals 150 are sandwiched between the third substrate 112 and the fourth substrate 111. The third polarizer 142 is disposed on an outside of the third substrate 112. The fourth polarizer 141 is disposed on an outside of the fourth substrate 111.

In particular, display light emitted from the first display panel 100 passes through the third polarizer 142 and becomes first polarized light. Because the transmission axis of the third polarizer 142 is parallel to the transmission axis of the first polarizer 241, the first polarized light can pass through the first polarizer 241 such that the second display panel 200 performs the function.

It should be explained that in some embodiment conditions, the first display panel 100 further comprises a backlight. The backlight is disposed on a side of the fourth polarizer 141 away from the fourth substrate 111, and the backlight is configured to supply the first display panel 100 with a light source.

In the present embodiment, the transmission axis of the first polarizer 241 is parallel to the transmission axis of the second polarizer 242, and the transmission axis of the third polarizer 142 is parallel to the transmission axis of the first polarizer 241. Display light of the first display panel 100, after passing through the third polarizer 142, can completely pass through the first polarizer 241. The display device 1000 has a high brightness effect. The display device 1000 of the embodiment of the present application has excellent anti-peep effect, high brightness, thin thickness and can simultaneously achieve the anti-peep function in three positions.

### Fourth Embodiment

The present embodiment is the same as or similar to the above embodiment, and a difference is that the display device 1000 is further described.

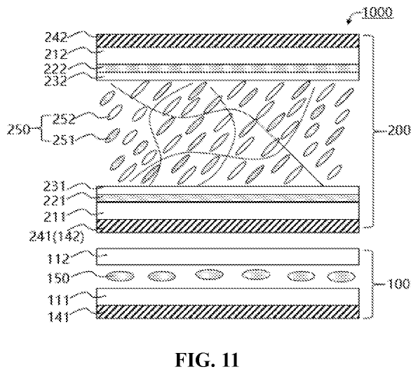

With reference to FIG. 11, FIG. 11 is a fourth schematic structural view of the display device 1000 provided by the embodiment of the present application.

In some embodiments, the third polarizer 142 and the first polarizer 241 are the same polarizer.

In particular, In the present embodiment, the transmission axis of the third polarizer 142 is parallel to the transmission axis of the first polarizer 241, therefore only one of the third polarizer 142 and the first polarizer 241 is kept to save a polarizer, which can reduce a thickness of the display device 1000 and lower a cost.

### Fifth Embodiment

the present embodiment provides a display device manufacturing method, the display device 1000 on any one of the above embodiments can be manufactured by employing the display device manufacturing method of the present embodiment.

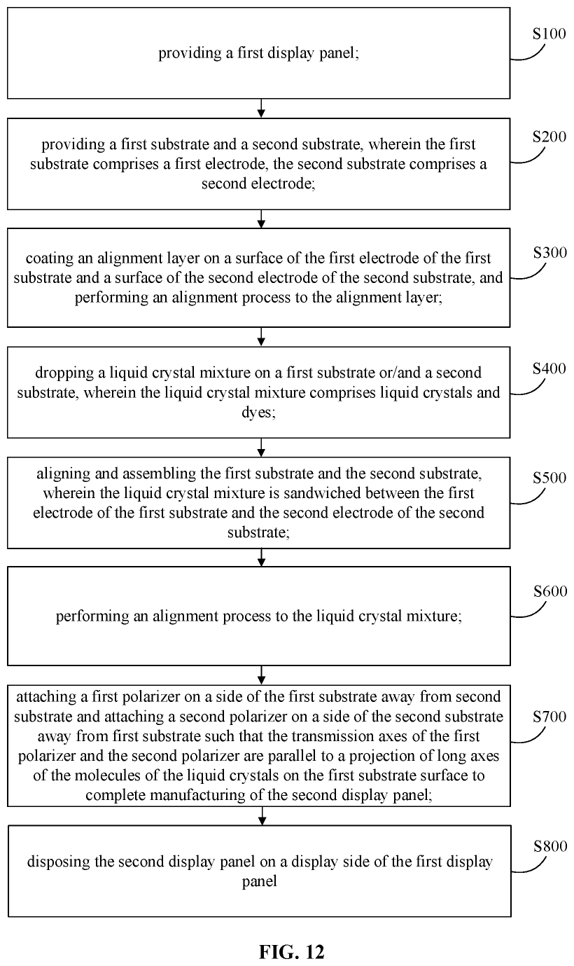

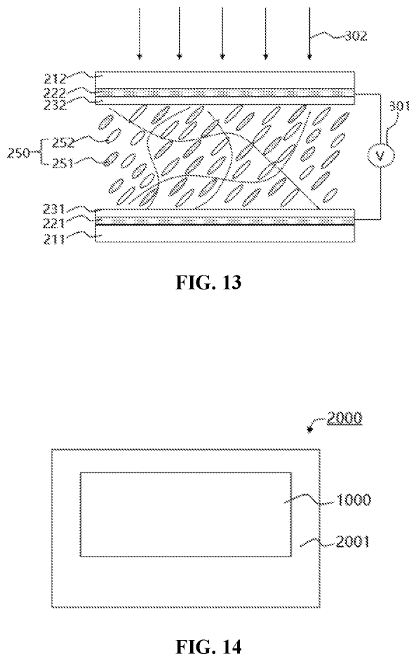

With reference to FIG. 12, FIG. 13, FIG. 12 is a schematic view of a flowchart of a manufacturing method for the display device 1000 provided by the embodiment of the present application; FIG. 13 is a schematic view of a liquid crystal mixture processed with an alignment process during manufacturing a second display panel 200 provided by the embodiment of the present application.

The present embodiment provides a display device manufacturing method, display device manufacturing method comprising manufacturing steps as follows: a step S100, a step S200, a step S300, a step S400, a step S500, a step S600, a step S700, and a step S800.

The step S100 comprises: providing a first display panel.

In particular, the first display panel is for display, can be a liquid crystal display panel, an organic light emitting display panel, etc., which is not limited here.

The step S200 comprises: providing a first substrate and a second substrate, wherein the first substrate comprises a first electrode, the second substrate comprises a second electrode.

In particular, the first electrode 221 is formed the first substrate 211, and the second electrode 222 is formed on the second substrate 212.

The step S300 comprises: coating an alignment layer on a surface of the first electrode of the first substrate and a surface of the second electrode of the second substrate, and performing an alignment process to the alignment layer.

In particular, a first alignment layer 231 is coated on the surface of the first electrode 221 of the first substrate 211, or a second alignment layer 232 is coated on the surface of the second electrode 222 of the second substrate 212.

In particular, the first alignment layer 231 is coated on the surface of the first electrode 221 of the first substrate 211, and simultaneously the second alignment layer 232 is coated on the surface of the second electrode 222 of the second substrate 212.

In particular, the alignment process of the alignment layer is rubbing alignment.

The step S400 comprises: dropping a liquid crystal mixture on a first substrate or/and a second substrate, wherein the liquid crystal mixture comprises liquid crystals and dyes.

In particular, the liquid crystal mixture 250 is dropped on the first substrate 211, or the liquid crystal mixture 250 is dropped on the second substrate 212. The liquid crystal mixture 250 comprises liquid crystals 251 and dyes 252.

In particular, the liquid crystal mixture 250 is dropped on the first substrate 211, and simultaneously the liquid crystal mixture 250 is dropped on the second substrate 212. The liquid crystal mixture 250 comprises liquid crystals 251 and dyes 252.

In particular, before the liquid crystal mixture is dropped on the first substrate or/and the second substrate, the method further comprises coating a frame sealant on first substrate or/and second substrate, which is not repeatedly described here.

The step S500 comprises: aligning and assembling the first substrate and the second substrate, wherein the liquid crystal mixture is sandwiched between the first electrode of the first substrate and the second electrode of the second substrate.

In particular, aligning and assembling the first substrate 211 and the second substrate 212 and sealing the first substrate 211 and the second substrate 212 by a frame sealant.

The step S600 comprises: performing an alignment process to the liquid crystal mixture such that molecules of the liquid crystals molecules of the dyes are aligned consistently and the molecules of the liquid crystals are obliquely aligned on a surface of the first substrate and a surface of the second substrate.

In particular, as shown in FIG. 13, a voltage 301 is applied to the first electrode 221 and the second electrode 222. Applying different voltages to the first electrode 221 and the second electrode 222 makes different pre-tilt angles of the molecules of the liquid crystals 251.

In particular, an electrical alignment is performed to the alignment process of the liquid crystal mixture and then a light curing process is performed. Namely, a predetermined voltage is applied to the first electrode 221 and the second electrode 222, the molecules of the liquid crystals 251 stand up according to a predetermined pre-tilt angle, and then ultra violet (UV) 302 irradiates an outside of the first substrate 211 or/and the second substrate 212, and the liquid crystals 251 has polymerization or curing reaction such that the molecules of the liquid crystals 251 form a stable predetermined pre-tilt angle, and the molecules of the dyes 252 under “guest-host” effect are arranged and aligned along the tilt angle of the molecules of the liquid crystals 251. Namely, the liquid crystal mixture 250 comprises the liquid crystals 251 and the dyes 252, the molecules of the liquid crystals 251 and the molecules of the dyes 252 are aligned consistently.

In particular, after the alignment of the liquid crystals 251 is completed, the predetermined voltage applied to the first electrode 221 and the second electrode 222 is removed, and the molecules of the liquid crystals 251 still maintains a stable alignment angle.

The step S700 comprises: attaching a first polarizer on a side of the first substrate away from second substrate and attaching a second polarizer on a side of the second substrate away from first substrate such that the transmission axes of the first polarizer and the second polarizer are parallel to a projection of long axes of the molecules of the liquid crystals on the first substrate surface to complete manufacturing of the second display panel.

In particular, a first polarizer 241 is attached on a side of the first substrate 211 away from the second substrate 212, a second polarizer 142 is attached on a side of the second substrate 212 away from the first substrate 211 to complete manufacturing of the second display panel 200.

In particular, a transmission axis of the first polarizer 241 is parallel to a transmission axis of the second polarizer 242, the transmission axis of the first polarizer 241 and the transmission axis of the second polarizer 242 are parallel to the projection of the long axes of the molecules of the liquid crystals 251 on the surface of the first substrate 211.

The step S800 comprises: disposing the second display panel on a display side of the first display panel.

In particular, the second display panel 200 is disposed on the display side of the first display panel 100 to complete manufacturing of the display device 1000. In particular, the second display panel 200 and the first display panel 100 can be disposed by a process of bonding and adhering or outer-frame fastening.

In some embodiments, the alignment process to the alignment layer in the step S300 is rubbing alignment; the alignment process to the liquid crystal mixture in the step S600 is electrical alignment and light curing.

In particular, the transmission axis of the first polarizer 241 is parallel to the transmission axis of the second polarizer 242. The transmission axes of the first polarizer 241 and the second polarizer 242 are parallel to the projection of the long axes of the molecules of the liquid crystals 251 on the surface of the first substrate 211.

### Sixth Embodiment

With reference to FIG. 14, FIG. 14 is a schematic view of the display device terminal 2000 provided by the embodiment of the present application.

The embodiment of the present application also provides a display terminal 2000, the display terminal 2000 comprises a terminal body 2001 and the display device 1000 of any one of the above embodiments. The terminal body 2001 and the display device 1000 are assembled integrally.

In particular, the display terminal 2000 can be cell phone, notebook, television, etc.

The display device and the display terminal provided by the embodiment of the present application are described in detail as above. In the specification, the specific examples are used to explain the principle and embodiment of the present application. The above description of the embodiments is only used to help understand the method of the present application and its spiritual idea. Meanwhile, for those skilled in the art, according to the present the idea of invention, changes will be made in specific embodiment and application. In summary, the contents of this specification should not be construed as limiting the present application.

What is claimed is:

1. A display device, comprising:
a first display panel, configured to display images; and
a second display panel disposed on a display side of the first display panel, wherein the second display panel comprises a first substrate, a second substrate, a first polarizer, a second polarizer, and a liquid crystal mixture, the first polarizer is disposed on a side of the first substrate away from the second substrate, the second polarizer is disposed on a side of the second substrate away from the first substrate, and the liquid crystal mixture is sandwiched between the first substrate and the second substrate;
wherein the liquid crystal mixture comprises liquid crystals and dyes, an alignment of molecules of the liquid crystals is consistent with an alignment of molecules of the dyes, the molecules of the liquid crystals and the molecules of the dyes are tilted relative to a surface of the first substrate.

2. The display device according to claim 1, wherein the second display panel further comprises a polymer network located between the first substrate and the second substrate, the polymer network is tilted relative to the surface of the first substrate, a tilt direction of the polymer network relative to the surface of the first substrate is consistent with a tilt direction of the molecules of the liquid crystals relative to the surface of the first substrate.

3. The display device according to claim 2, wherein a transmission axis of the first polarizer is parallel to a transmission axis of the second polarizer, the transmission axes of the first polarizer and the second polarizer are parallel to a projection of long axes of the molecules of the liquid crystals on the first substrate surface.

4. The display device according to claim 1, wherein an included angle between the long axes of the molecules of the liquid crystals and the surface of the first substrate and an included angle between long axes of the molecules of the dyes and the surface of the first substrate are 45 to 90 degrees.

5. The display device according to claim 1, wherein a mass ratio of the dyes in the liquid crystal mixture is 1% to 5%.

6. The display device according to claim 1, wherein the first display panel further comprises a third substrate and a third polarizer, a display unit is disposed on the third substrate, the third polarizer is disposed between the third substrate and the first substrate, and a light transmission axis of the third polarizer is parallel to the transmission axis of the first polarizer.

7. The display device according to claim 6, wherein the third polarizer and the first polarizer are the same polarizer.

8. The display device according to claim 6, wherein the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

9. The display device according to claim 7, wherein the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

10. The display device according to claim 1, wherein the dyes comprise azo dyes or anthraquinone dyes.

11. A display terminal, comprising a terminal body and a display device, wherein the terminal body and the display device are assembled integrally, and the display device comprises:
a first display panel, configured to display images; and
a second display panel disposed on a display side of the first display panel, wherein the second display panel comprises a first substrate, a second substrate, a first polarizer, a second polarizer, and a liquid crystal mixture, the first polarizer is disposed on a side of the first substrate away from the second substrate, the second polarizer is disposed on a side of the second substrate away from the first substrate, and the liquid crystal mixture is sandwiched between the first substrate and the second substrate;
wherein the liquid crystal mixture comprises liquid crystals and dyes, an alignment of molecules of the liquid crystals is consistent with an alignment of molecules of the dyes, the molecules of the liquid crystals and the molecules of the dyes are tilted relative to a surface of the first substrate.

12. The display terminal according to claim 11, wherein the second display panel further comprises a polymer network located between the first substrate and the second substrate, the polymer network is tilted relative to the surface of the first substrate, a tilt direction of the polymer network relative to the surface of the first substrate is consistent with a tilt direction of the molecules of the liquid crystals relative to the surface of the first substrate.

13. The display terminal according to claim 12, wherein a transmission axis of the first polarizer is parallel to a transmission axis of the second polarizer, the transmission axes of the first polarizer and the second polarizer are parallel to a projection of long axes of the molecules of the liquid crystals on the first substrate surface.

14. The display terminal according to claim 11, wherein an included angle between the long axes of the molecules of the liquid crystals and the surface of the first substrate and an included angle between long axes of the molecules of the dyes and the surface of the first substrate are 45 to 90 degrees.

15. The display terminal according to claim 11, wherein a mass ratio of the dyes in the liquid crystal mixture is 1% to 5%.

16. The display terminal according to claim 11, wherein the first display panel further comprises a third substrate and a third polarizer, a display unit is disposed on the third substrate, the third polarizer is disposed between the third substrate and the first substrate, and a light transmission axis of the third polarizer is parallel to the transmission axis of the first polarizer.

17. The display terminal according to claim 16, wherein the third polarizer and the first polarizer are the same polarizer.

18. The display terminal according to claim 16, wherein the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

19. The display terminal according to claim 17, wherein the first display panel is a liquid crystal display panel, the first display panel further comprises a fourth substrate and a fourth polarizer, the fourth substrate is disposed on a side of the third substrate away from the third polarizer, and the fourth polarizer is disposed on a side of the fourth substrate away from the third substrate.

20. The display terminal according to claim 11, wherein the dyes comprise azo dyes or anthraquinone dyes.
